(19) United States
(12) Patent Application Publication
(10) Pub. No.: US 2007/0039518 A1
(43) Pub. Date: Feb. 22, 2007

(54) Process for creating a printing format

(75) Inventors: Detlef Schulze-hagenest, Molfsee (DE); Frank-Michael Morgenweck, Kiel (DE); Domingo Rohde, Kiel (DE); Lars Seimetz, Achterwehr (DE); Dinesh Tyagi, Fairport, NY (US); Udo Draeger, Speyer (DE)

Correspondence Address: PATENT LEGAL STAFF, EASTMAN KODAK COMPANY, 343 STATE STREET, ROCHESTER, NY, 14650-2201, US

(73) Assignee: EASTMAN KODAK COMPANY, Rochester, NY (US)

(21) Appl. No.: 10/568,039

(22) PCT Filed: Aug. 12, 2004
(86) PCT No.: PCT/US04/26191

§ 371 Date: Sep. 25, 2006

(30) Foreign Application Priority Data
Aug. 13, 2003 (DE) 103 37 157.5

(51) Int. Cl. C09K 3/00; C09D 4/00; C09D 1/00; C09D 11/00; C09D 5/00

(52) U.S. Cl. 106/31.02

(57) ABSTRACT

The smell of the printing medium and/or the printing format is at least influenced. At least one toner that contains at least one aromatic substance, or one ink, that contains at least one aromatic substance is applied to a printing medium. For this purpose, appropriate toners or inks and processes for their manufacture, as well as a printing machine for implementing an appropriate printing process, are introduced.

### FIELD OF THE INVENTION

The subject invention pertains to a toner-based process and machine for creating a printing format on a printing medium, a toner, or an ink, for creating this printing format, and a manufacturing process for the production of the toner or the ink.

### BACKGROUND OF THE INVENTION

A toner-based process for creating printing formats on printing media includes, for example, electrophotographic, magneto-graphic, and electrostatic printing processes. In a toner-based printing process, a printing format is created on a printing medium essentially by applying toner to the surface of the printing medium.

In a toner-based printing process, such as an electrophotographic printing process, toner can be transferred onto the printing medium directly by an electrophotographic imaging cylinder or an imaging tape, or indirectly through intermediately located transfer. In this process, imaging of a printing medium or a transfer is accomplished in a separate printing unit for each color. Imaging is also achieved by applying different toner colors onto a printing medium in a repetitious process using the same printing unit.

After the toner has been transferred onto the printing medium it must be fused. For this purpose, contact-making fuser processes that use pressure and heat are available, but contact-free fusing processes are also available. In contact-free fusing, the toner can be fused by electromagnetic waves, ultra-violet waves, infrared radiation, or microwave radiation, for example.

After the image has been fused the printing medium can be further processed. The printing medium can subsequently, for example, be doped, folded, and/or bound. It can also, for example, be cut down to a smaller size.

The printing media can be paper in various sizes, foils, paperboards, and other materials that are capable of being imaged in a printing machine. The finished printed product can, for example, be a book, a magazine, a newspaper, packaging materials, post cards, or greeting cards.

As a rule, these products are either sold or they are used to sell something for which advertising is done either in them or through them. In any case, in most cases they are supposed to make a favorable impression. For this purpose, for example, special decorative colors are used in the printing process or the printing is done on special printing media. In this regard, colors in addition to the “standard” printing colors of cyan (C), magenta (M), yellow (Y), and black (K) can be used. One newspaper can distinguish itself from other newspapers, for example, by using a special color of red in large areas of the newspaper. In the printing of labels, for instance, gold colored foil is imprinted for the purpose of creating a particularly rich impression.

### SUMMARY OF THE INVENTION

The objective of the subject invention is to disclose a preferably toner-based process with which the impression made by a printed product can be even further improved. The objective is achieved with respect to the process in that the smell of the printing medium and/or the printing format is at least influenced.

It is well known that smells have a positive effect upon people. For example, today, pleasant smelling scent stations are set up in department stores or supermarkets to make people feel better. It is not even necessary that the smell be easily perceptible.

During the Christmas season, aromatic oils or incense-burning mannequins are used to create moods. Oils that smell, for example, likes oranges or cinnamon are heated in incense burners. If, then, the smell of a printing medium and/or a printing format is at least influenced then it is possible for the printed product to have a special scent that is different from its natural odor and that can create a desired impression. This scent can be limited to certain areas of the printed product or it can extend throughout the entire printed product. It is possible, in particular, for the different areas of a printed product to have different scents.

For example, in one and the same newspaper an advertisement for a new automobile can have a new car smell, while just a few pages later an advertisement for a prepared meal can smell like noodle sauce. By such means, it is beneficially possible to improve the impression created by these advertisements and to further improve a reader's already favorable reaction to the advertised product.

It is also possible to influence the smell of a Christmas card such that it smells like cinnamon, oranges, and cardamom so that both the sender and the recipient are automatically reminded of Christmas as they handle and smell the card. By this means, the sale of such Christmas cards can be increased.

In a beneficial further step of the process, provision is made for at least one toner containing at least one aromatic substance to be applied to the printing medium. In this way, the smell of a printing medium and/or the printing format can be simply varied inside a printing machine. An additional advantageous fringe benefit results from an improvement of the smell in the vicinity of this printing machine. Where before the smell of solvent filled the air, now the air smells like “Christmas” or whatever the particular scent in use is reminiscent of.

Different toners can be applied to the printing medium in a printing process. Thus, it is possible, for example, to place two different scents on one side of the medium. It is conceivable that “before and after” photos could achieve greater effect with the use of different scents.

In a particularly beneficial further development of the process, provision is made for applying to the printing medium at least one toner that is essentially colorless, but contains at least one aromatic substance.

In this way, a conventional printing process can be performed using traditional toners that—aside from their natural scent—are odorless. Afterwards, the olfactory impression made by the printed product can at least be influenced by additional toners that are essentially colorless and thus do not change the optical characteristics of the printing format. It can also be possible to apply the aromatic substances by of colorless toners that will very decidedly change the optical impression created by the printing format, in that they affect the glossiness of the printing format to the extent desired. Printing media on which no printing format is to be created can also be imprinted with essentially colorless toners. Such printing media thus advantageously retain their original appearance.

Provision is also made according to the invention for the use of ink that contains an aromatic substance. In an appropriate further development of the invention, such ink can also be colorless. The advantages of using this ink are first of all the same as those already described for toner. In addition, the use of ink permits the process to be beneficially carried out with a conventional desktop printer. Thus, the process can be utilized at a very favorable cost and on a very personal level.

The objective of the invention is further achieved according to the invention by a toner or, alternatively, an ink that contains at least one aromatic substance whose purpose it is to at least influence the scent emitted by the printing medium and/or the printing format. Thus, the process described above can be executed with the use of this toner or, alternatively, this ink.

In a particularly beneficial manufacturing process used for the production of the toner according to the invention and the ink according to the invention, provision is made for an aromatic substance to be added to a standard toner or ink, preferably in concentrated form.

In an electrophotographic printing machine, this aromatic substance can be combined with a fusing oil either as an additive or alone, whereby then the olfactory impression made by the entire printing medium is at least influenced. In this way, it becomes unnecessary that different combinations of colors and scents be compiled for toners, each of which would have to be purchased by the consumer.

A consumer can continue to use the toner that he has been using and then, as needed, add an aromatic substance of his choice to a toner of his choice. This is a particularly flexible production process that is also financially advantageous for the consumer.

While not intended to be all-inclusive, the following represents a list of possible aromatic substances that can be added to a toner:

Lemon oil, clove, geranium, lavender, peppermint, rosemary, eucalyptus, thyme, pine needle, ilang-ilang, cinnamon, orange, cardamom, and rum. However, more complicated aromatic substances are also possible as follows: cat food, dog food, soap, leather, freshly mown grass, or the like. There are, in fact, no limits with respect to the aromatic substances that may be used.

In addition, the objective of the invention is achieved by a printing machine that incorporates at least one printing unit for applying to a printing medium a toner, or an ink, that contains an aromatic substance. Such a printing machine according to the invention is, in particular, a digital printing machine that creates a printing format on a printing medium during a toner-based printing process.

Toner-based printing processes are, for example, electrophotographic, magneto-graphic, or electrostatic printing processes. Digital printing processes should, in particular, be used. Personalized printing formats, for example, can be beneficially created by such a printing process.

In a further development according to the invention, provision is made for the at least one printing unit to be an electrophotographic printing unit that is located upstream from the fuser mechanism. When this is the case, the toner containing the aromatic substance can be fused simultaneously with the other toners used in the printing machine.

In an alternative or additional embodiment, provision is made according to the invention for the ink that contains an aromatic substance to be applied to the printing medium downstream from the fuser mechanism. When this is the case the already fused toner image on the printing medium is not additionally affected, but the scent of the printing format or the printing medium can be further influenced. In this regard, too, personalized printing is made possible.

In addition, it is possible according to the invention to use one or more electrophotographic printing units and/or ink jet mechanisms for applying toners and/or inks containing aromatic substances. When this is done, it is possible to create an individual scent profile for different printing media. The personalized printing that is possible in toner-based printing machines can thus be extended to the sphere of scenting.

The invention, and its objects and advantages, will become more apparent in the detailed description of the preferred embodiment presented below.

### BRIEF DESCRIPTION OF THE DRAWINGS

Embodiments of a process for creating a printing format on a printing medium according to the invention, from which additional characteristics according to the invention can be derived, but to which the scope of the invention is not limited, are shown in the following drawings.

FIG. 1 shows a schematic representation of a printing machine that incorporates a printing unit for applying a toner according to the invention;

FIG. 2 shows a representation of a printing format on a printing medium; and

FIG. 3 shows a representation of an alternative printing machine that incorporates an external printing unit.

### DETAILED DESCRIPTION OF THE INVENTION

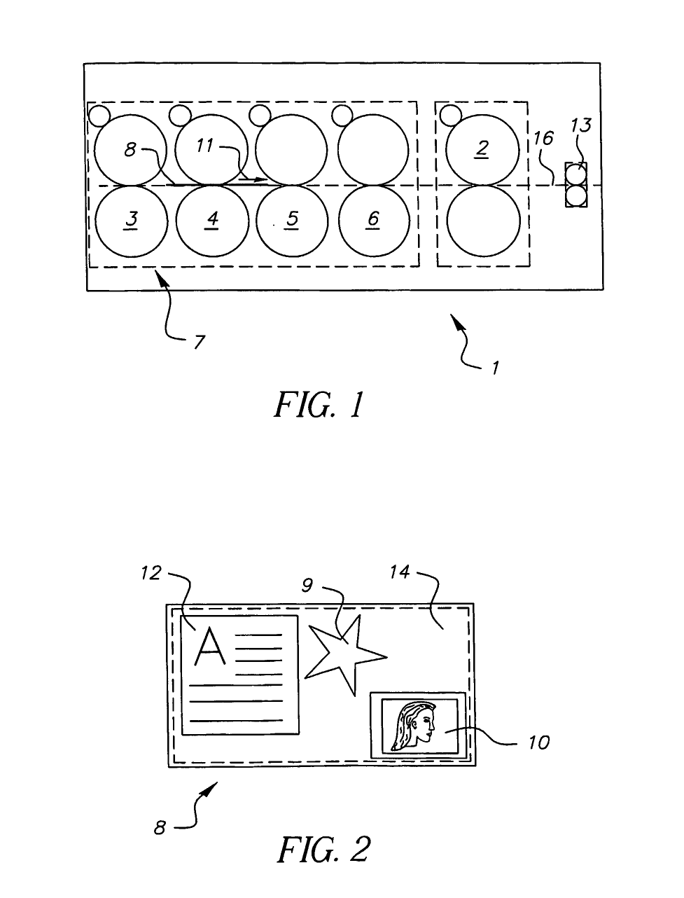

Referring now to the accompanying drawings, FIG. 1 is a cross-sectional view of a printing machine 1. In addition to printing units 3 through 6, which transfer toner for the colors cyan (C), magenta (M), yellow (Y), and black (K) onto a printing medium 8, this printing machine incorporates a fifth printing unit 2, which transfers, for example, a colorless toner containing aromatic substances onto the printing medium 8. The toner can contain, for example, aromatic substances such as cinnamon or clove. For the sake of graphic simplicity and to simplify the description that follows, the printing units 3 through 6 are grouped together in one printing mechanism 7 within the printing machine 1.

The printing medium 8 can, for example, be a Christmas card. FIG. 2 shows an appropriate printing medium 8 containing a printing format 14. This printing format 14 can then be schematically divided into different areas 9, 10, and 12. The area 12 is made up of textual material and the area 10 contains graphic elements. The area 9 also contains graphic elements, in this example, the scents of which are, however, to be influenced according to the invention.

As shown in FIG. 1, the printing medium 8 is being conveyed for this purpose lengthwise along a travel path 16 through the printing mechanism 7 in the direction shown by the arrow 11. The printing format 14 is formed on the surface of the printing medium 8 by means of the CMYK toner from the printing mechanism 7.

Downstream from the printing mechanism 7, the printing medium 8 passes through the fifth printing unit 2. Here, the colorless toner is applied to the area 9.

Finally, the printing format 14 is fused onto the printing medium 8 in the fuser mechanism 13. The result is the imprinted printing medium 8, which is shown in FIG. 2 containing an area 9 that smells like Christmas. The area 9 can be, for example, a representation of photographs of cinnamon stars.

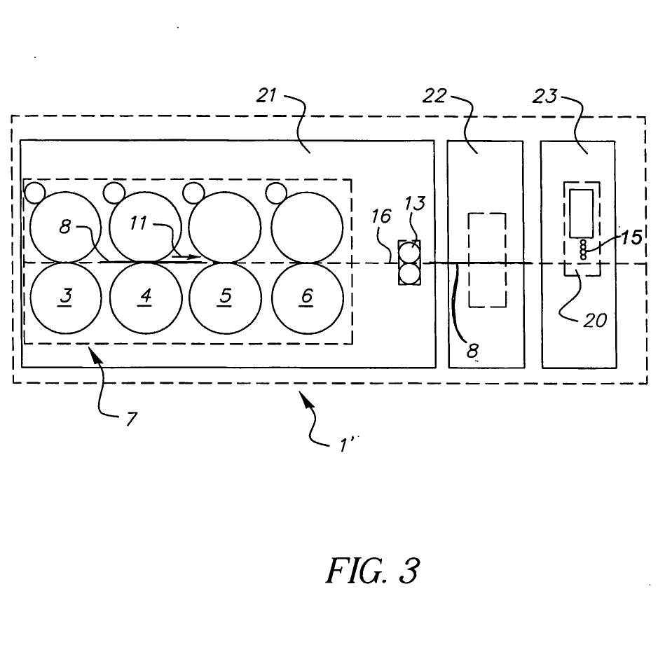

FIG. 3 shows an alternative printing machine 1′ that incorporates an external printing unit 23. The same printing format that includes the same areas 9, 10, and 12 on the printing medium 8 can, in general be created using this printing machine 1′, as is shown in FIG. 2. The numbers used here to identify like elements are the same as those used in the two previous drawings.

As was the case in the printing machine 1 shown in FIG. 1, the CMYK toner is applied here to the printing medium 8 in the printing mechanism 7. As opposed to what happened in the process described with respect to FIG. 1, here the printing medium 8 passes through the fuser mechanism 13 directly downstream from the printing mechanism 7.

The printing machine 1′ is structured modularly, whereby the printing mechanism 7 and the fuser mechanism 13 are assembled in one module 21. This module 21 can, in particular, be an already existing printing machine. An additional processing unit 22 is then located in the form of a free-standing module downstream from the fuser mechanism 13. This unit 22 can, for example, include a doping mechanism, and can dope the entire printing format 14 on the printing medium 8 or only one of the areas 9, 10, and 12.

Subsequently, the printing medium 8 is conveyed into the aromatic substance module. Here, the printing medium 8 passes through an ink jet mechanism 20, which transfers, an essentially colorless ink 15 onto the printing medium 8. The same aromatic substances cinnamon and clove are added to the ink 15 as were added to the colorless toner in the previous example. The ink 15 is finally transferred onto the area 9 of the printing format 14, which represents a cinnamon star. This process permits the creation of a greeting card containing a Christmas aroma.

Beneficially, a conventional printing machine, the module 21, can be used for this purpose. Then, a printing machine 1′ can be formed by combining additional modules 22 and 23, or even more modules. This option is always available and variations thereof can be implemented in a printing plant. Different modules 22, etc. can be used to further treat the printing medium. Downstream of the module 22, the ink that has been enriched with an aromatic substance is then applied. Other additional modules along the travel path 16 of the printing medium 8 are also conceivable, modules that can, for example, fold and cut the printing medium.

The aroma emitted from an area 9 of a printing format 14 on a printing medium 8 can be easily manipulated by the use of the two processes which have been introduced here and which can be used by the printing machines 1 and 1′. In order to assure that the scent emitted from this area 9 can continue to be recognized over the course of time, provision is made for the concentration of aromatic substance in the toner or in the ink 15 to be 10 to 100 times greater than the threshold concentration required for the scent to be generally detectable.

Both processes can be used in printing machines 1 and 1′, machines that provide for personalized printing. If different printing units 2 or scent modules 23 are used, toners or inks containing different aromatic substances can be applied to subsequently, conveyed printing media 8. Thus, this process is very flexible. In particular, with the use of modular structuring in a printing plant different scent modules 23 can be attached to different printing machines at will or they can mutually expand one printing machine.

1. A process, preferably toner-based, for said creation of a printing format (14) on a printing medium (8), characterized by the scent of said printing medium (8) and/or said printing format (14) is at least influenced.

2. A process according to claim 1, characterized by at least one toner that contains at least one aromatic substance is applied to said printing medium (8).

3. A process according to claim 1, characterized by at least one essentially colorless toner that contains at least one aromatic substance is applied to said printing medium (8).

4. A process according to claim 1, characterized by at least one ink that contains at least one aromatic substance is applied to said printing medium (8).

5. A process according to claim 1, characterized by at least one essentially colorless ink (15) that contains at least one aromatic substance is applied to said printing medium.

6. Toner for creating a printing format (14) on a printing medium (8), characterized by said toner including at least one aromatic substance for at least influencing said smell of said printing medium (8) and/or said printing format (14).

7. Ink for creating a printing format (14) on a printing medium (8), characterized by said ink including at least one aromatic substance for at least influencing said smell of said printing medium (8) and/or said printing format (14).

8. A manufacturing process for said production of a toner according to claim 6, characterized by at least one aromatic substance is added, in concentrated form, to an ordinary toner.

9. A manufacturing process for said production of an ink according to claim 7, characterized by at least one aromatic substance is added, in concentrated form, to an ordinary ink.

10. A printing machine for said creation of a printing format on a printing medium, in a printing process that is toner-based, characterized by at least one printing unit for applying to a printing medium (8) a toner that contains an aromatic substance or an ink (15) that contains an aromatic substance.

11. A printing machine according to claim 10, characterized by at least one printing unit being an electrophotographic printing unit (2) that is located in said area upstream of a fuser mechanism (13) of said printing machine.

12. A printing machine according to claim 10, characterized by at least one printing unit being an ink jet mechanism (20) that is located in said area downstream of a fuser mechanism (13) of said printing machine.
